(19) United States
(12) Patent Application Publication
(10) Pub. No.: US 2011/0188662 A1
(43) Pub. Date: Aug. 4, 2011

(54) METHOD OF RENDERING BINAURAL STEREO IN A HEARING AID SYSTEM AND A HEARING AID SYSTEM

(75) Inventors: Morten Holm JENSEN, Farum (DK); Mike Lind RANK, Farum (DK); Preben KIDMOSE, Maalov (DK)

(73) Assignee: WIDEX A/S, Lynge (DK)

(21) Appl. No.: 13/083,080

(22) Filed: Apr. 8, 2011

Related U.S. Application Data
(63) Continuation-in-part of application No. PCT/DK2008/000363, filed on Oct. 14, 2008.

(51) Int. Cl. H04R 25/00

(52) U.S. Cl. 381/23.1

(57) ABSTRACT

A hearing aid system comprising means (304) for receiving a multi-channel digitally encoded audio signal (301) and means (306) for rendering said received multi-channel signal into a binaural stereo signal. The invention further provides a method for replaying audio streams in hearing aids.

### RELATED APPLICATIONS

The present application is a continuation-in-part of application No. PCT/DK2008000363, filed on Oct. 14, 2008, in Denmark and published as WO2010043223 A1.

### BACKGROUND OF THE INVENTION

1. Field of the Invention

The present invention relates to hearing aids. The invention, more specifically, relates to a hearing aid system for rendering a multi-channel digitally encoded audio signal into a binaural stereo signal. The invention further relates to a method of replaying audio streams in hearing aids.

2. The Prior Art

US-A1-20080008341 discloses a hearing assistance system that presents sound to both ears of a user wearing wireless hearing assistance devices, which sound is derived from a single monaural signal. Among other things, it allows for better control of the received sound and obtains benefits of binaural hearing for listening to the monaural signal. In various embodiments, the sound presented to one ear is phase shifted relative to the sound presented to the other ear. In some embodiments, the phase shift arises from a constant time delay or the phase shift arises from a constant phase shift at all frequencies. In other embodiments, the phase shift arises from a phase shift that is varying as a function of frequency. In still other embodiments, the sound presented to one ear is set to a different level relative to the sound presented to the other ear. In further embodiments, the sound presented to one ear is controllable in relative phase and in relative level with respect to the sound presented to the other ear.

WO-A1-2006133158 discloses a hearing aid system adapted for wireless communications between one or more wireless audio devices and other electronics for providing e.g. streaming audio and other enhanced hearing functions. Mono and stereo communication modes are supported in various embodiments. In one embodiment an interface device has a first port, which is adapted to receive information from a communication device. The information is subsequently processed or formatted if required, and transmitted wirelessly to one or more audio devices. In one application, streaming audio packets are received from the communication device and in some embodiments the streaming audio is in stereo. The interface device can transmit stereo information that is received by the proper wireless audio device to preserve the stereo nature of the information. In one application the communication device includes a computer connected to a content source over a network, such as the Internet. In one application, it includes a storage device, such as an iPod™ or other streaming audio device. In one application it includes a connection to a wireless audio source. In one application it includes a wireless connection to a Bluetooth MP3 player. One application includes a wired stereo or mono connection.

WO-A1-200674655 discloses a hearing aid system, which enables signals of arbitrary origin to be transmitted from a portable module to one or more hearing aids. This feature may, for instance, be used for transferring digital audio signals to the hearing aid from the portable module. The transmission of data may be from an external source, such as a personal computer or similar appliance, wirelessly to the hearing aid via the portable module.

US-A1-20060018497 discloses a communication system where exactly matched, but generally slightly different acoustic signals can be created and directed to the user's left and right ear. This means that it is possible for the left and the right ear of a user to be fed acoustic signals which are slightly phase-shifted and adapted in their amplitude, so that the user gets the impression that an acoustic signal generated or stored in a hearing aid or communication system is coming from a specific direction of the space. The user thus gets the impression that the acoustic signal originates from an acoustic signal source with a certain position in the space.

US-B1-5438623 discloses a method for imposing spatial cues to a plurality of audio input signals using synthetic head related transfer functions (HRTFs). Hereby the plurality of audio input signals will be perceived by the user as emerging from a corresponding plurality of predetermined directions.

US-B1-6307941 discloses a system and method for providing improved virtual sound images. One or more spatial cues of an audio signal may be modulated within a desired range to increase the clarity and perceived localization of the virtual sound image. Hereby a system that is less sensitive to head movements of the user is achieved.

US-A1-20050117762 discloses a more computational efficient implementation of HRTF filters with no detectable deterioration of output quality. This invention uses a cascade of resonators and anti-resonators similar to those used in speech synthesizers to model the vocal tract transfer function for implementing HRTF filters. Further an algorithm that creates a wider sound image by processing only two channels of audio is disclosed. Finally virtual surround systems, which employ algorithms that try to localize sounds in virtual space using head-related transfer functions (HRTFs) are disclosed.

For replay of sound there are a number of formats in use. In mono replay there is one channel of sound, and the sound can be replayed by a single loudspeaker. For traditional stereo replay, two channels are provided, and the listener will normally replay them using two loudspeakers. The loudspeakers will preferably be arranged in the listening theatre vis-à-vis the listener in a triangle in equal distances to the listener and with a wide spacing symmetrical about the listeners preferred direction of view in order to offer the maximum of spatial experience. Stereo recordings of music and other sound bits will normally be optimized for this kind of listening. Other sound formats used today are surround sound systems with five, six or even more channels arranged in a spatial pattern around the user. A listener with unimpaired hearing will hear sound from any of the speakers with both ears, shading effects of the head and the external ear colouring the sound, whereby the listener can distinguish among the sources.

Hearing aid systems have been developed for listening to traditional stereo signals. However, when listening to such a signal through a set of hearing aids, the sound will not be subjected to shading effects and the stereo image will be perceived as being narrow and “inside the head”.

It is a feature of the present invention to overcome this shortcoming and make a hearing aid system capable of delivering binaural stereo signals. Hereby it becomes possible for the hearing aid user to perceive the stereo image as being wider and more natural.

It is also well known to experience listening fatigue when listening to traditional stereo signals in headphones. It is a further feature of the present invention to overcome this drawback when listening to traditional stereo signals streamed to a pair of hearing aids and make a hearing aid system capable of rendering binaural stereo signals that may relieve the hearing aid user from listening fatigue. This can be done by introducing frequency dependent cross talk between the traditional stereo signals. The relief from listening fatigue may be provided by a number of alternative techniques, as will be known in the art.

Today, many home entertainment appliances are capable of providing the necessary output to drive a traditional surround sound system. As an example many DVD movies comprise surround sound. Many hearing aid users prefer to have their hearing aids linked directly to e.g. the television or DVD player and in this way bypass both the television speaker and hearing aid microphone. Hereby e.g. ambient noise and reverberations will not interfere with the television or DVD signal, and it therefore becomes possible to improve both the signal to noise ratio and speech intelligibility of the audio signal.

However, a digital surround sound signal cannot be played back directly through a set of hearing aids. It is a feature of the current invention to overcome this drawback by providing a hearing aid system capable of delivering binaural stereo signals. Hereby it becomes possible for the hearing aid user to perceive the surround sound signal through a set of hearing aids.

### SUMMARY OF THE INVENTION

The invention, in a first aspect, provides a hearing aid system comprising a left hearing aid, a right hearing aid, and an associated device, said associated device being adapted for digitally encoding an audio signal defining a left and a right audio input stream, said associated device comprising rendering means adapted for receiving and decoding said digitally encoded audio signal for providing a left rendered signal by a first linear sum of digitally filtered versions of the left and the right audio input streams and a right rendered signal by a second linear sum of digitally filtered versions of the left and the right audio input streams, said associated device comprising transmission means for transmitting the left and the right rendered signal to the left and the right hearing aid, each of the left and right hearing aids having means for decoding and playing a respective rendered signal.

This provides a hearing aid system comprising a left and a right hearing aid and a rendering device, wherein the rendering device is adapted for receiving and decoding a digitally encoded audio signal defining at least two audio input streams and for rendering two output signals defining a binaural stereo signal and for transmitting the two output signals as a left and a right rendered signal to the first and the second hearing aid, each of said first and second hearing aid having means for decoding and playing a respective rendered signal.

Hereby an advanced listening feature is achieved, which would otherwise be denied many hearing aid users because most hearing aid types does not interact conveniently with head phones, which are generally the preferred tool for enjoying binaural stereo.

This advanced listening feature is achieved without compromising size or electrical power requirements in the hearing aid units themselves, because the rendering device carries out the signal processing required by the binaural stereo rendering. Additionally the decoding in the hearing aid units has been simplified to so called mono-decoding for additional savings with respect to size and electrical power requirements in the hearing aid units themselves. Furthermore, making the rendering processing in the rendering device avoids distortions because the binaural rendering is only carried out once, as opposed to being carried out in both hearing aids independently of each other and based on an input signal that may have been distorted during the transmission from audio device to hearing aid. Finally the necessary bandwidth required for the signal transmitted to the hearing aids is reduced in cases where the number of channels in the received multi-channel digitally encoded audio signal exceeds the two channels that are required for transmitting a binaural stereo signal.

The invention, in a second aspect, provides a hearing aid system comprising a left hearing aid, a right hearing aid, and an associated device, said associated device being adapted for digitally encoding and transmitting an audio signal defining at least a left and a right audio input stream, said left hearing aid comprising left hearing aid rendering means adapted for receiving and decoding said digitally encoded audio signal for providing a left rendered signal by a first linear sum of digitally filtered versions of the left and the right audio input streams and for playing said left rendered signal, and said right hearing aid comprising right hearing aid rendering means adapted for receiving and decoding said digitally encoded audio signal for providing a right rendered signal by a second linear sum of digitally filtered versions of the left and the right audio input streams and for playing said right rendered signal.

The invention, in a third aspect, provides a method for replaying a first and a second audio stream in a pair of hearing aids, comprising receiving the first and the second audio stream in a rendering means, processing the first and the second audio stream in the rendering means to produce a first output signal by a first linear sum of digitally filtered versions of the first and the second audio stream and a second output signal by a second linear sum of digitally filtered versions of the first and the second audio stream, transmitting the first and the second output signal from the rendering means as a left and a right rendered signal to a left and a right hearing aid, and replaying a respective rendered signal in each of said left and right hearing aid.

This provides a method for replaying at least two audio streams in a pair of hearing aids comprising receiving the at least two audio streams in a rendering device, processing the at least two audio streams in the rendering device to produce two output signals defining a binaural stereo signal, transmitting the two output signals from the rendering device as a left and a right rendered signal to a left and a right hearing aid, and playing a respective rendered signal in each of said left and right hearing aid.

Further advantageous features appear from the other dependent claims.

Still other feature of the present invention will become apparent to those skilled in the art from the following description wherein embodiments of the invention will be explained in greater detail.

### BRIEF DESCRIPTION OF THE DRAWINGS

By way of example, there is shown and described a preferred embodiment of this invention. As will be realized, the invention is capable of other different embodiments, and its several details are capable of modification in various, obvious aspects all without departing from the invention. Accordingly, the drawings and descriptions will be regarded as illustrative in nature and not as restrictive. In the drawings:

FIG. 1 illustrates a highly schematic and simplified block diagram of a hearing aid system according to an embodiment of the present invention;

FIG. 2 illustrates a highly schematic and simplified block diagram of a hearing aid system according to another embodiment of the present invention;

FIG. 3 illustrates a highly schematic and simplified block diagram of a hearing aid system according to another embodiment of the present invention;

FIG. 4 illustrates a highly schematic implementation of a hearing aid system according to another embodiment of the present invention;

FIG. 5 illustrates schematically a typical listening situation for replay of a traditional audio stereo signal through a pair of loudspeakers; and

FIG. 6 illustrates a highly simplified block diagram of a part of a hearing aid system for rendering a traditional stereo signal into a binaural stereo signal according to an embodiment of the present invention.

### DETAILED DESCRIPTION

In order to more fully detail the present invention some terms used in the definition of the invention are explained in the following.

In the present disclosure, a hearing aid should be understood as a small, battery-powered, microelectronic device designed to be worn behind or in the human ear by a hearing-impaired user. Prior to use, the hearing aid is adjusted by a hearing aid fitter according to a prescription in order to alleviate a hearing loss by amplifying frequencies in those parts of the audible frequency range where the user has difficulties in perceiving sounds. The prescription is based on a hearing test, which results in an audiogram, signifying the performance of the hearing-impaired user's unaided hearing. A hearing aid comprises one or more microphones, a battery, a microelectronic circuit comprising a signal processor, and an acoustic output transducer. The signal processor is preferably a digital signal processor. The hearing aid is enclosed in a casing suitable for fitting behind or in a human ear. The microphone in the hearing aid converts sounds from the surroundings into an analog, electrical signal. The digital signal processor in the hearing aid converts the analog electrical signal from the microphone into a digital form by virtue of an analog-to-digital converter, and subsequent signal processing is carried out in the digital domain. A hearing aid may come in different styles, such as Behind-the-Ear (BTE), In-the-Ear (ITE) or Completely-in-Canal (CIC) types.

In the present disclosure “a hearing aid system” comprises a pair of hearing aids, in order to allow replay of binaural stereo. In addition to the hearing aids themselves the hearing aid system may comprise one or more associated devices, e.g. devices adapted for wireless audio streaming to the hearing aids. In the following the associated devices may also be denoted rendering devices.

The general term audio device, as opposed to associated device or rendering device, includes all sorts of devices, capable of delivering a digital audio output such as e.g. televisions, DVD recorders, computers, mp3 players and mobile phones. The typical output from these devices will be a multi-channel digitally encoded audio signal.

An audio signal, in the general meaning of the term comprises all the sounds that may be received by a hearing aid system using e.g. a microphone. As opposed to this, a digitally encoded audio signal is a digital signal representing sounds that have been recorded and coded in a digital format. Therefore a hearing aid system can only receive a digitally encoded audio signal using a digital input means such as e.g. Bluetooth receivers, FM receivers or digital plugs and cables. With respect to binaural rendering it is a significant advantage to consider only digitally encoded audio signals because the digital formats comprise information on the placement of the intended loudspeakers relative to the listener. This information is e.g. specified in the various commercial surround sound formats. For traditional audio stereo signals of digital origin it is reasonable to assume an intended loudspeaker placement at +/−30 degrees relative to the listener.

The general term “rendering” is used to refer to a digital transformation, where an audio signal in one digital format is transformed into another digital format suitable for being replayed to a user. I.e. a multi-channel digitally encoded audio signal comprising more than two channels may be rendered for replay by only two channels.

In the present disclosure “binaural rendering” refers to the process where any multi-channel digitally encoded audio signal is rendered for replay of binaural stereo by two hearing aids. A specific type of binaural rendering transforms a traditional digitally encoded audio stereo signal into a binaural stereo signal. Binaural stereo is explained in more detail below.

In the present disclosure the term “mono rendering” refers to the process where any multi-channel digitally encoded audio signal is rendered for replay of only one of the two channels required to generate binaural stereo. Therefore replay of binaural stereo by two hearing aid units using the mono rendering process, requires the process to be adapted to the hearing aid unit, in such a way that the hearing aid units provide the appropriate binaural stereo channel. I.e. the left hearing aid unit provides the left binaural stereo channel and the right hearing aid unit provides the right binaural stereo channel. It follows directly that the mono rendering process requires only half the processing power of the binaural rendering process.

A“multi-channel signal” is a signal that includes two or more channels intended for simultaneous replay, e.g. by respective speakers. Stereo and surround sound recordings include multi-channel signals. Examples of multi-channel formats are Channel Surround 2.0, 2.1, 3.0, 4.0, 5.1, 6.1, 7.1, 10.2 and 22.2.

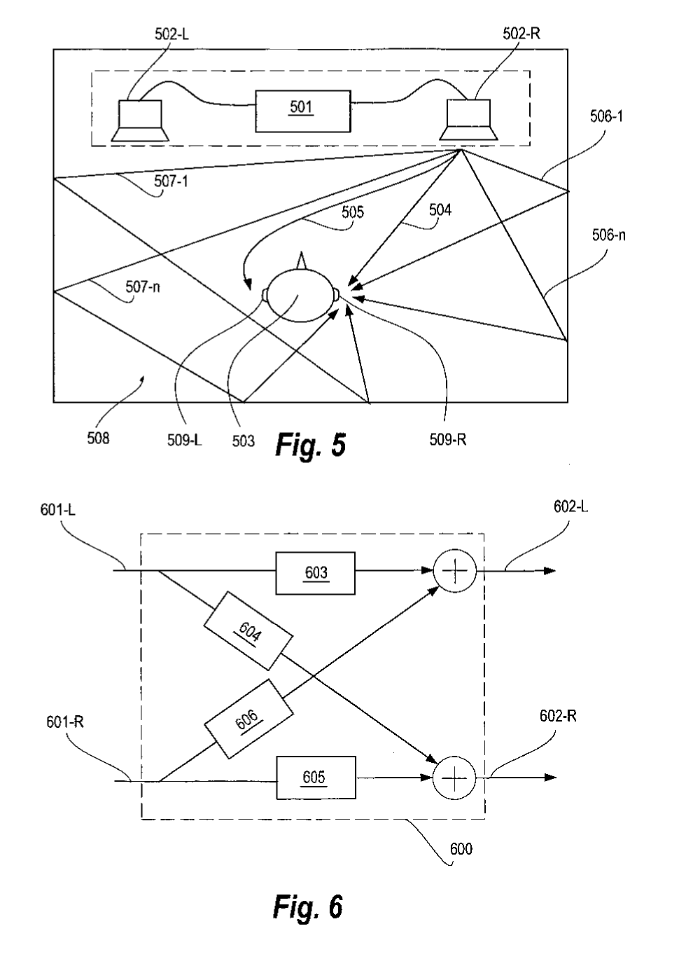

In the present disclosure “binaural stereo” is provided by simulating or improving a multi-channel digitally encoded audio signal using two hearing aid units. Typically the method of providing binaural stereo consists of processing a multi-channel digitally encoded audio signal with psychoacoustic sound localization methods to simulate a multi-dimensional sound field for a user wearing two hearing aids. Binaural stereo and the various methods for providing it is further described below with reference to FIG. 5 and FIG. 6.

In this application “transmission means” and “receiving means” should be understood as means for connecting audio devices to the hearing aid system and means for interconnecting the various parts of the hearing aid system. Such means may be telecoils, FM transmitters and receivers, Bluetooth transmitters and receivers, other wireless digital transmitter and receiver types, optical plugs and cables, digital coax plugs and cables as well as any other type of wired or wireless transmitting and receiving means. Thus, in the present application such transmitting and receiving means may be incorporated in both the audio devices and the units of the hearing aid system. The transmitting and receiving means in the various units need not be the same and a single unit may comprise more than one type. Especially in hearing aid systems with several associated devices the transmission types need not be the same, since the choice depends on the system requirements for the specific transmission path. As an example the transmission format used for signal transmission to the hearing aids themselves should be optimized for requiring minimal electrical power for the signal decoding in the hearing aids.

It is well known to use an audio codec algorithm in order to represent an audio signal with a minimum number of bits while retaining the quality. This can effectively reduce the bandwidth required for transmission of an audio file. Examples of audio codecs are MP3, WMA, AAC and AC-3 (digital dolby). In the present application the term “audio decoder” refers to means for decoding an audio encoded signal. The “audio decoder” typically detects the transmission format of the received digital audio signal and decodes the signal appropriately. Correspondingly the “audio encoder” processes the audio encoding of the given audio signal.

“Mono-decoding” of a digital stereo signal (which may be either a binaural or a traditional stereo signal) is a process where one of the two input stereo channels is decoded and the other of the two input stereo channels is discarded. Thus in the left hearing aid unit the right channel of the stereo signal is discarded and in the right hearing aid unit the left channel of the stereo signal is discarded. Hereby the required processing power for the “mono-decoding” is only half or less that of the traditional audio decoding of a multi-channel signal.

Reference is first made to FIG. 6, which shows a block diagram of a part of a hearing aid system for rendering a digitally encoded stereo audio signal into a digital binaural stereo signal according to an embodiment of the present invention. FIG. 6 illustrates a digital filter configuration 600 adapted for processing a first digital input signal 601-1 representing a left traditional stereo channel, and a second digital input signal 601-1 representing a right traditional stereo channel in order to output a first digital output signal 602-1 representing a left binaural stereo channel, and a second digital output signal 602-r representing a right binaural stereo channel. The left binaural stereo channel 602-1 is the sum of the first digital input signal 601-1 filtered by a first digital filter 603 and the second digital input signal 601-r filtered by a second digital filter 604. The right binaural stereo channel 602-r is the sum of the first digital input signal 601-1 filtered by a third digital filter 605 and the second digital input signal 601-r filtered by a fourth digital filter 606.

The first digital filter 603 represents the transfer function for sound transmitted from a left loudspeaker to the left ear of a listener inclusive HRTF and room impulse response.

The second digital filter 604 represents the transfer function for sound transmitted from a left loudspeaker to the right ear of a listener inclusive HRTF and room impulse response.

The third digital filter 605 represents the transfer function for sound transmitted from a right loudspeaker to the right ear of a listener inclusive HRTF and room impulse response.

The fourth digital filter 606 represents the transfer function for sound transmitted from a right loudspeaker to the left ear of a listener inclusive HRTF and room impulse response.

Reference is now made to FIG. 5, which shows schematically a typical listening situation for replay of a traditional audio stereo signal of digital origin through a set of loudspeakers. FIG. 5 illustrates a stereo set 500, comprising a stereo processor unit 501 and left and right loudspeakers 502-1, 502-r. A listener 503, with a right ear 509-r and a left ear 509-1, receives the sound emitted from both loudspeakers. The stereo set and the listener are positioned in a room 508.

For reasons of simplicity only sound emitted from the right loudspeaker and to the right ear is considered in the following. When sound is emitted from the right loudspeaker 502-r, the direct sound 504 reaches the right ear 509-r first. Then, the reflective sounds from the walls and the ceiling (506-1, . . . 506-n) arrive. Further, the sound waves having been subjected to repeated multiple reflections on the surrounding walls (507-1, . . . , 507-n) reach the right ear as reverberation. If for example, a very short sound with a flat frequency response is emitted from the loudspeaker, the listener receives a time series of the reflected sound. This is called the “impulse response”. The impulse response contains information about the acoustical properties of a room.

The knowledge of the typical impulse response of various locations such as a living room, church or concert hall may be used in processing for simulating a virtual acoustic reality. This kind of processing can be implemented in a hearing aid system, according to the present invention, adapted to offer the user the choice between a variety of virtual locations, that the user may prefer for listening.

In the listening situation shown in FIG. 5 the sound received at each ear of the listener is a linear combination of the sound emitted from the left and the right loudspeaker. Head Related Transfer Functions (HRTFs) are response functions that characterize how a given single-channel audio signal from a given location is perceived by a listener. This means that the HRTF can be used to determine the relation between the signal 504 from the right loudspeaker 502-r and to the right ear 509-r and the signal 505 from the right loudspeaker and to the left ear 509-1. Therefore the HRTFs contain information that is necessary to render binaural stereo in a set of hearing aids.

The HRTF can be captured in an anechoic chamber, using a model of a human head, with microphones placed in the ear canals.

In an embodiment of the present invention the binaural stereo signal is provided based on more than two digital input signals. Hereby digital surround sound signals having more than two channels can be rendered for binaural stereo.

The binaural stereo effect may also be provided using a number of alternative transformation techniques, as will be known in the art.

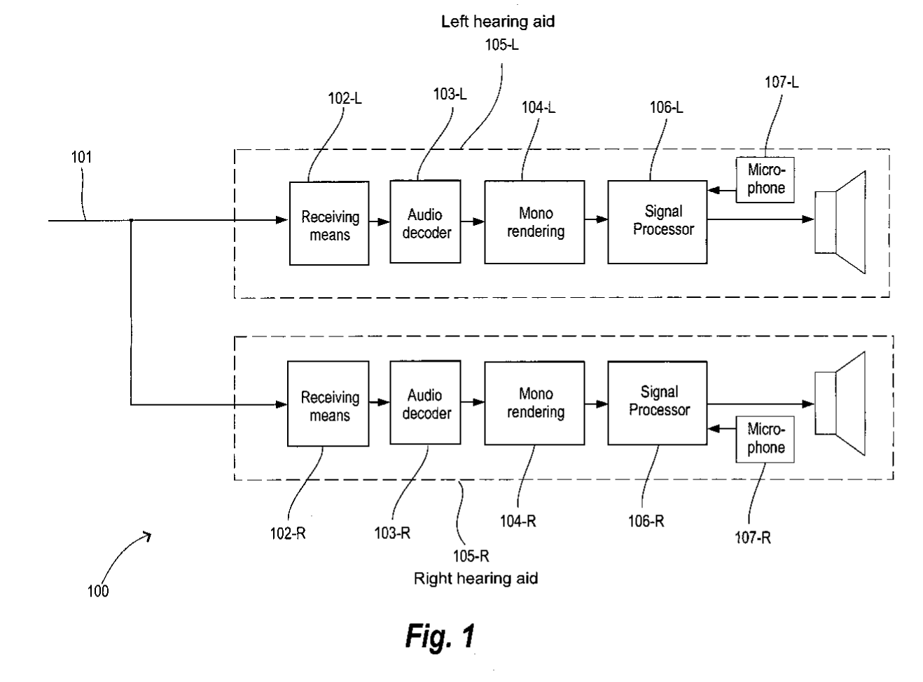

Reference is now made to FIG. 1, which shows a highly schematic and simplified block diagram of a part of a hearing aid system according to an embodiment of the present invention. FIG. 1 illustrates a pair of hearing aids 100, comprising a left and a right hearing aid 105-L and 105-R, each adapted for receiving a multi-channel digitally encoded audio signal 101, and further comprising means 102-L, 102-R for receiving said multi-channel signal, means 103-L, 103-R for audio decoding said received multi-channel signal, means 104-L, 104-R for mono rendering in order to provide a binaural stereo signal using the corresponding left and right ear hearing aids. It is noted that the hearing aid microphones 107-L and 107-R are not used for providing the binaural stereo signal. The binaural stereo signal outputs from the mono rendering means are used as input to digital signal processors 106-L and 106-R in each of the hearing aid units. The hearing aids have microphones 107-L and 107-R, which pick up ambient sound and feed it into signal processors, 106-L and 106-R. The digital signal processor mixes the inputs and carry out the hearing loss compensation. The processors may comprise controls for selecting among the inputs, or for adjusting the balance among them.

Hereby an advanced listening feature is achieved, which would otherwise be denied many hearing aid users because most hearing aid types does not interact conveniently with head phones, which are generally the preferred tool for enjoying binaural stereo.

In one embodiment the receiving means is a Bluetooth receiver, and the audio device (which is not shown in FIG. 1) is a Bluetooth enabled personal computer. Therefore the personal computer is capable of providing the hearing aid units with MP3 coded audio stereo signals. The audio decoder in the hearing aid unit is capable of decoding the MP3 coding and the rendering transforms the traditional stereo signal into a binaural stereo signal with a wider stereo image.

In another embodiment the receiving means is a telecoil and the audio device (which is not shown in FIG. 1) is a telecoil system that has been adapted for pulse-width coding in order to allow a stereo signal to be transmitted. The audio decoder in the hearing aid unit decodes the pulse-width coded signal, and the rendering transforms the traditional stereo signal into a binaural stereo signal with a wider stereo image.

Alternatively, the binaural stereo signal is provided based on a digital surround sound signal having more than two channels. Hereby a user may enjoy virtual surround sound through a pair of hearing aids.

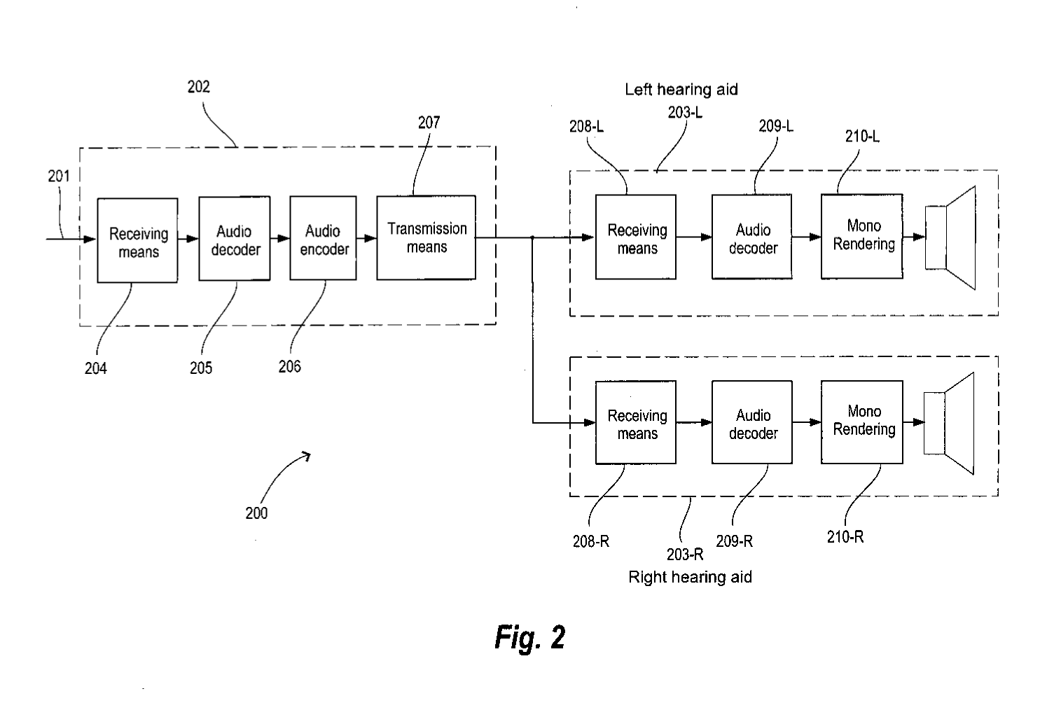

Reference is now made to FIG. 2, which shows a highly schematic and simplified block diagram of a hearing aid system according to another embodiment of the invention. FIG. 2 illustrates the hearing aid system 200, generally comprising an associated device 202, left and right hearing aid units 203-L, 203-R. The associated device comprises receiving means 204 for receiving a multi-channel digitally encoded audio signal 201 from an audio device (not shown in FIG. 2), an audio decoder 205 for decoding said received multi-channel signal, an audio encoder 206 for adapting said received signal for transmission to the hearing aids and transmission means 207 for transmitting the encoded signal. The hearing aids 203-L, 203-R further comprise receiving means 208-L, 208-R for receiving said transmitted signal, decoding means 209-L and 209-R for decoding said received signal, and rendering means 210-L, 210-R for mono rendering in order to provide a binaural stereo signal using the corresponding left and right ear hearing aids. The hearing aids further comprise microphones and signal processors (not shown in FIG. 2) configured as discussed above with reference to FIG. 1.

In an embodiment the associated device is a hearing aid remote control adapted for allowing cable connection to a streaming audio device, such as an MP3 player.

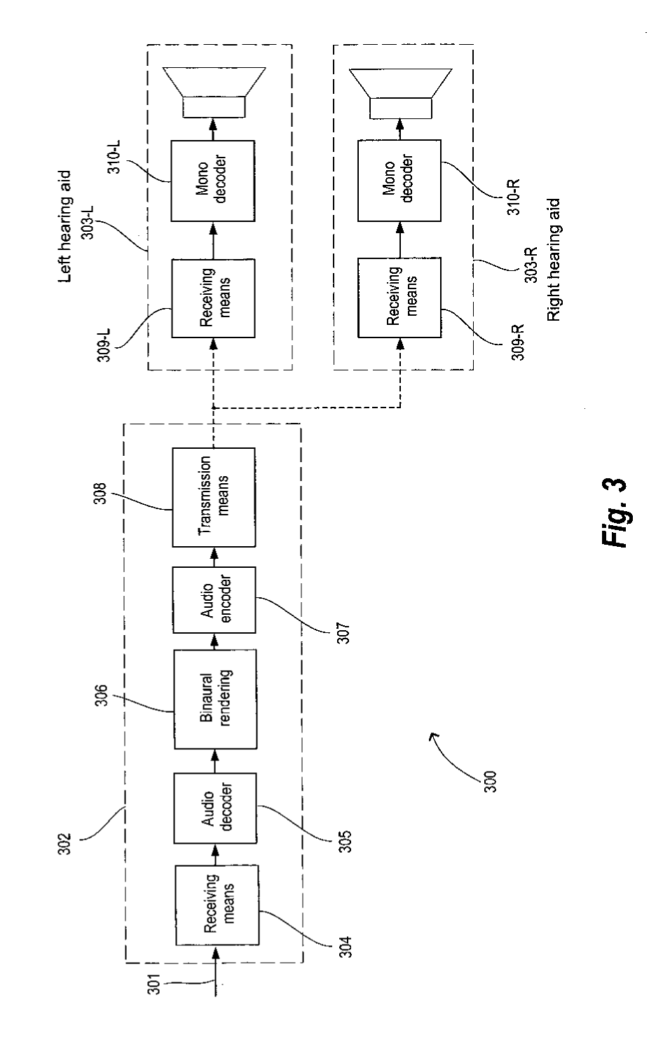

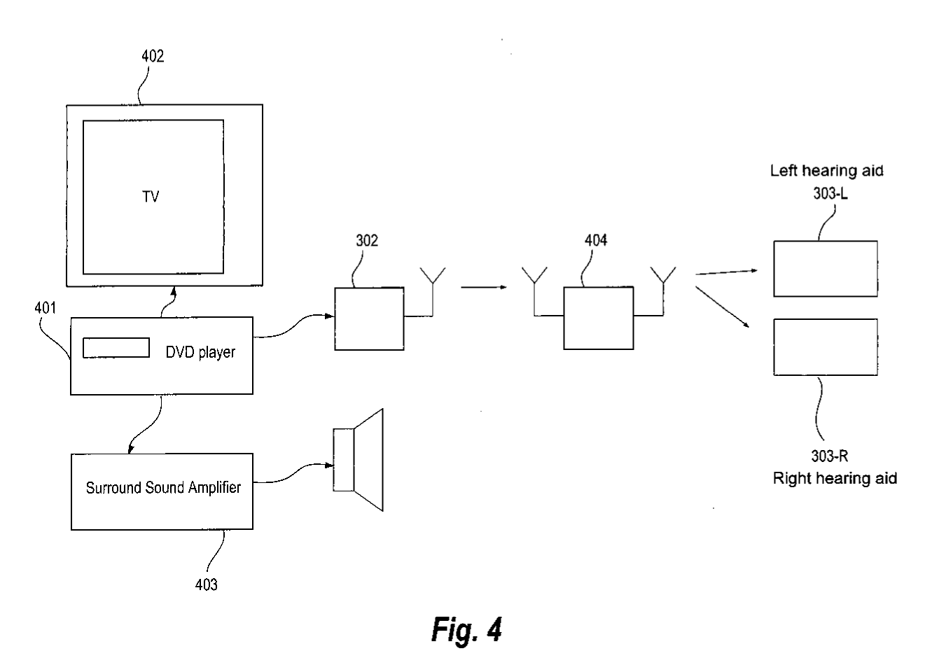

The hearing aid systems 200 and 300 (refer to FIG. 3) may further comprise additional associated devices. An example of such a hearing aid system is described with reference to FIG. 4.

Reference is now made to FIG. 3, which shows a highly schematic and simplified block diagram of a hearing aid system according to an embodiment of the present invention. FIG. 3 illustrates the hearing aid system 300, generally comprising an associated device 302 and left and right hearing aids 303-L, 303-R. The associated device further comprises receiving means 304 for receiving a multi-channel digitally encoded audio signal 301, an audio decoder 305 for decoding the received multi-channel signal, means 306 for rendering the decoded signal into a binaural stereo signal, means 307 for encoding the binaural stereo signal for transmission towards the two hearing aids and means 308 for transmitting the encoded signal towards the two hearing aids 303-L, 303-R. The hearing aids further comprise means 309-1, 309-R for receiving a transmitted signal, means 310-L and 310-R for mono decoding the received signal in the corresponding left and right hearing aid units and microphones and signal processors (not shown in FIG. 3) configured as discussed above with reference to FIG. 1.

Hereby an advanced listening feature is achieved without compromising size or electrical power requirements in the hearing aids themselves, because the associated device carries out the signal processing required by the binaural stereo rendering. Additionally the decoding in the hearing aid units has been simplified to so called mono-decoding for additional savings with respect to size and electrical power requirements in the hearing aid units themselves.

Furthermore, the resulting binaural stereo signal is less sensitive to possible distortions of the signal transmitted from the associated device towards the respective hearing aids.

Reference is now made to FIG. 4, which shows an illustration of a specific embodiment of the present invention. FIG. 4 shows a DVD player 401, that supports DVDs with multi-channel digitally encoded audio. The DVD player is connected to a television set 402, a surround sound amplifier 403 and a first associated device 302 dedicated for binaural rendering, encoding and subsequently wirelessly transmitting the binaural stereo signal to a second associated device 404, which is adapted for relaying wirelessly the audio signal further on to the respective hearing aids 303-L and 303-R. The second associated device ensures that the wireless signal transmission consumes a minimum of electrical power in the hearing aids. Hereby the hearing aid user can enjoy the full benefit of the audio surround sound that today is a part of many DVD movies. Furthermore it should be appreciated that the complex and therefore power consuming binaural rendering process is carried out by the first associated device, that may be connected to a wall plug as opposed to the second associated device and the hearing aids that will normally be battery powered.

In an embodiment the television set, DVD player, the surround sound amplifier and first associated device are connected with digital coax cables.

In another embodiment the first associated device functions as base station for the second associated device and wherein the second associated device functions as a hearing aid remote control.

Other modifications and variations of the structures and methods will be evident to those skilled in the art.

We claim:

1. A hearing aid system comprising a left hearing aid, a right hearing aid, and an associated device, said associated device being adapted for digitally encoding an audio signal defining a left and a right audio input stream, said associated device comprising rendering means adapted for receiving and decoding said digitally encoded audio signal for providing a left rendered signal by a first linear sum of digitally filtered versions of the left and the right audio input streams and a right rendered signal by a second linear sum of digitally filtered versions of the left and the right audio input streams, said associated device comprising transmission means for transmitting the left and the right rendered signal to the left and the right hearing aid, each of the left and right hearing aids having means for decoding and playing a respective rendered signal.

2. The hearing aid system according to claim 1, wherein the associated device comprises a user input means and a remote control output.

3. The hearing aid system according to claim 1, wherein the rendering means comprises a digital filter configuration wherein each of the two output signals is provided as a linear sum of digitally filtered versions of all the audio input signals.

4. The hearing aid system according to claim 1, wherein the rendering means comprises a receiver for receiving the digitally encoded audio signal.

5. The hearing aid system according to claim 1, wherein the rendering means is adapted for rendering the two output signals by subjecting the at least two audio input streams to frequency dependent cross talk.

6. The hearing aid system according to claim 1, wherein the rendering means is adapted for processing a multi-channel audio input stream.

7. The hearing aid system according to claim 1, wherein the rendering means is adapted for rendering the two output signals by subjecting the left and right audio input streams to a head related transfer function.

8. The hearing aid system according to claim 7, wherein the rendering means has means for selecting cues for the head related transfer function for simulating a specific listening environment such as one selected from the group living room, church and concert hall.

9. The hearing aid system according to claim 8, wherein the cues for the rendering means have been derived by measuring the acoustic impulse response of a selected acoustic environment.

10. The hearing aid system according to claim 6, wherein the associated device is a portable, battery-powered device.

11. The hearing aid system according to claim 6, wherein the associated device is adapted for being powered from a wall socket.

12. The hearing aid system according to claim 11, wherein the associated device is adapted for functioning as base station for a hearing aid remote control.

13. A hearing aid system comprising a left hearing aid, a right hearing aid, and an associated device, said associated device being adapted for digitally encoding and transmitting an audio signal defining at least a left and a right audio input stream, said left hearing aid comprising left hearing aid rendering means adapted for receiving and decoding said digitally encoded audio signal for providing a left rendered signal by a first linear sum of digitally filtered versions of the left and the right audio input streams and for playing said left rendered signal, and said right hearing aid comprising right hearing aid rendering means adapted for receiving and decoding said digitally encoded audio signal for providing a right rendered signal by a second linear sum of digitally filtered versions of the left and the right audio input streams and for playing said right rendered signal.

14. A method for replaying a first and a second audio stream in a pair of hearing aids, comprising receiving the first and the second audio stream in a rendering means, processing the first and the second audio stream in the rendering means to produce a first output signal by a first linear sum of digitally filtered versions of the first and the second audio stream and a second output signal by a second linear sum of digitally filtered versions of the first and the second audio stream, transmitting the first and the second output signal from the rendering means as a left and a right rendered signal to a left and a right hearing aid, and replaying a respective rendered signal in each of said left and right hearing aid.

15. The method according to claim 14, comprising rendering the first and the second output signals by subjecting the left and right audio input streams to a head related transfer function.
